(19) United States
(12) Patent Application Publication
(10) Pub. No.: US 2013/0083532 A1
(43) Pub. Date: Apr. 4, 2013

(54) ALTERNATING CURRENT LIGHT-EMITTING DEVICE

(71) Applicant: Chi Mei Lighting Technology Corp., Tainan (TW)

(72) Inventor: Yen-Wei Chen, Tainan (TW)

(73) Assignee: Chi Mei Lighting Technology Corp., Tainan (TW)

(21) Appl. No.: 13/629,040

(22) Filed: Sep. 27, 2012

(30) Foreign Application Priority Data
Oct. 4, 2011 (TW) 100135906

(51) Int. Cl. F21V 21/00

(52) U.S. Cl. 362/249.02

(57) ABSTRACT

An alternating current light-emitting diode (AC LED) device. In one embodiment, the AC LED device includes a primary light-emitting module and a secondary light-emitting module. Each of the primary light-emitting module and the secondary light-emitting module comprises a plurality of light-emitting diodes (LEDs). The secondary light-emitting module is disposed adjacent to the primary light-emitting module. A light-emitting area of each LED in the secondary light-emitting module is smaller than a light-emitting area of each LED in the primary light-emitting module.

### CROSS-REFERENCE TO RELATED APPLICATION

This non-provisional application claims priority under 35 U.S.C. §119(a) on Patent Application No. 100135906 filed in Taiwan R.O.C. on Oct. 4, 2011, the entire contents of which are hereby incorporated by reference.

Some references, if any, which may include patents, patent applications and various publications, may be cited and discussed in the description of this invention. The citation and/or discussion of such references, if any, is provided merely to clarify the description of the present invention and is not an admission that any such reference is “prior art” to the invention described herein. All references listed, cited and/or discussed in this specification are incorporated herein by reference in their entireties and to the same extent as if each reference was individually incorporated by reference.

### FIELD OF THE INVENTION

The present invention relates generally to a light-emitting device (LED), and more particularly to an alternating current (AC) LED for improving light-emitting efficiency.

### BACKGROUND OF THE INVENTION

Generally, light-emitting diodes (LEDs) are widely applied in a white-light illumination device, an indicator lamp, a vehicle signal lamp, a vehicle headlamp, a flash lamp, a backlight module of a liquid crystal display, a light source of a projector, an outdoor display unit, and the like. However, a light-emitting source of a current LED cannot be directly operated with an alternating current (AC) power supply, so it is required to convert an AC to a direct current (DC) through a rectifier (AC/DC) before the light source of the LED stably emits light. FIG. 1A shows a conventional AC-driven LED (AC LED) 1. The AC-driven LED 1 is formed by an externally added bridge rectification circuit (LEDs D1-1 to D1-4, D2-1 to D2-4, D3-1 to D3-4, and D4-1 to D4-4) and a cascade high voltage LED (LEDs D5-1 to D5-9). FIG. 1B shows an equivalent circuit of the conventional AC-driven LED 1 in FIG. 1A. As shown in FIG. 1A, the LEDs D5-1 to D5-9 in the conventional AC-driven LED 1 are equivalent to a primary light-emitting element D5 in FIG. 1B, the LEDs D1-1 to D1-4, D2-1 to D2-4, D3-1 to D3-4, and D4-1 to D4-4 are equivalent to secondary light-emitting elements D1, D2, D3, and D4 in FIG. 1B, and the secondary light-emitting elements D1 to D4 may also rectify an AC input into a DC output. Therefore, no matter whether an AC signal is a positive bias or negative bias, the primary light-emitting element D5 maintains light-emitting, but the secondary light-emitting elements D1 and D3 emit light only when the AC signal is a positive bias, and the secondary light-emitting elements D2 and D4 emit light only when the AC signal is a negative bias. In other words, the primary light-emitting element D5 is on and emits light at any time, and a part of secondary light-emitting elements are on and emit light only when the AC signal is a positive bias or a negative bias. It is assumed that an area of each LED of the conventional AC-driven LED 1 is set to 1. A total area of the whole AC-driven LED 1 is LED chips of 16 secondary light-emitting elements plus LED chips of 9 primary light-emitting elements, so the total area is 25. The duty-on time of the primary light-emitting element is 100%, and the duty-on time of the secondary light-emitting element is 50%. Therefore, in the case that the AC signal is the positive bias or the negative bias, an effective light-emitting area of the conventional AC-driven LED 1 is 16*0.5+9*1=17. Since the secondary light-emitting element of the conventional AC-driven LED 1 cannot emit light due to an inverse bias in half of a period, the effective light-emitting area of the LED is reduced, and optimal efficiency cannot be achieved.

Since the AC-driven LED cannot effectively improve the light-emitting efficiency, a novel AC light-emitting device needs to be provided, to improve the light-emitting efficiency of the whole AC light-emitting device.

### SUMMARY OF THE INVENTION

In one aspect, the present invention is directed to an AC light-emitting device, capable of improving the light-emitting efficiency, prolonging the service life of each LED in the AC light-emitting device, and meanwhile considering the reliability requirement of the whole AC light-emitting device.

In an embodiment, an AC light-emitting device of the present invention includes a primary light-emitting module and a secondary light-emitting module. Each of the primary light-emitting module and the secondary light-emitting module comprises a plurality of LEDs. The secondary light-emitting module is disposed adjacent to the primary light-emitting module. A light-emitting area of each LED in the secondary light-emitting module is smaller than a light-emitting area of each LED in the primary light-emitting module.

These and other aspects of the present invention will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the invention and together with the written description, serve to explain the principles of the invention.

Wherever possible, the same reference numbers are used throughout the drawings to refer to the same or like elements of an embodiment, and wherein:

FIG. 1A is a schematic diagram of a conventional AC-driven LED;

FIG. 1B is an equivalent circuit diagram of FIG. 1A;

FIG. 2 shows an AC light-emitting device according to an embodiment of the present invention;

FIGS. 3A and 3B are schematic circuit operation diagrams of an AC light-emitting device in the case that an AC input power supply is a positive signal;

FIGS. 4A and 4B are schematic circuit operation diagrams of an AC light-emitting device in the case that an AC input power supply is a negative signal; and

FIGS. 5A and 5B are graphs of a relationship between an area ratio of a single LED in a primary light-emitting module to a single LED in the secondary light-emitting module and a brightness increase rate of an AC light-emitting device.

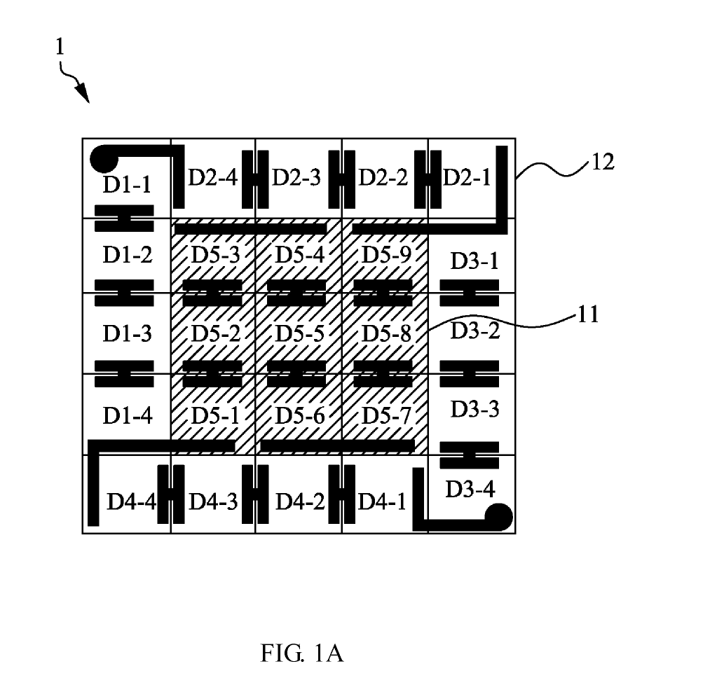

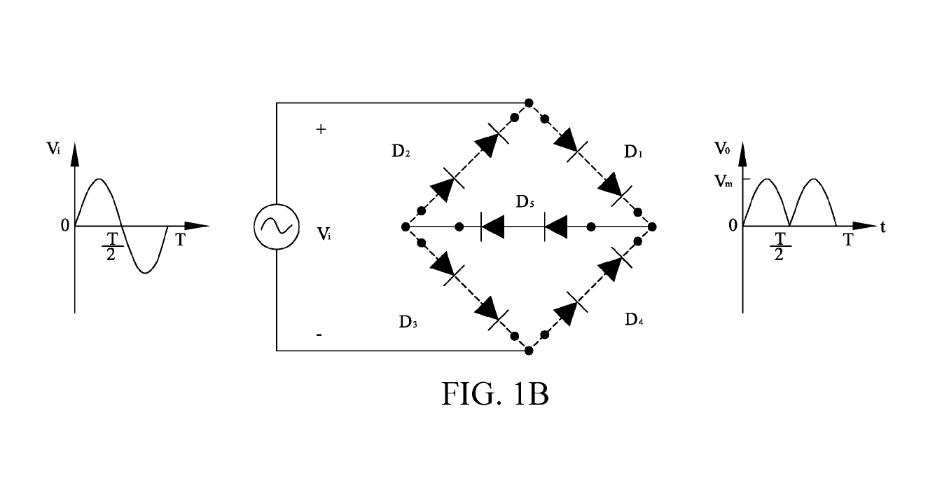

### DETAILED DESCRIPTION OF THE INVENTION

The present invention is more particularly described in the following examples that are intended as illustrative only since numerous modifications and variations therein will be apparent to those skilled in the art. Various embodiments of the invention are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present invention. Additionally, some terms used in this specification are more specifically defined below.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, the terms “comprising”, “including”, “carrying”, “having”, “containing”, “involving”, and the like are to be understood to be open-ended, i.e., to mean including but not limited to.

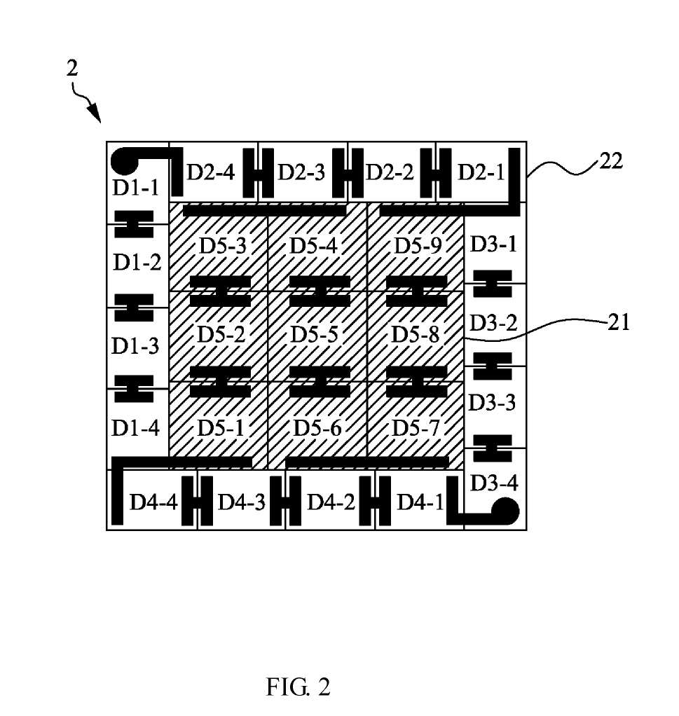

The description will be made as to the embodiments of the present invention in conjunction with the accompanying drawings in FIGS. 2-5. In accordance with the purposes of this invention, as embodied and broadly described herein, this invention, in one aspect, relates to an AC LED device for improving light-emitting efficiency.

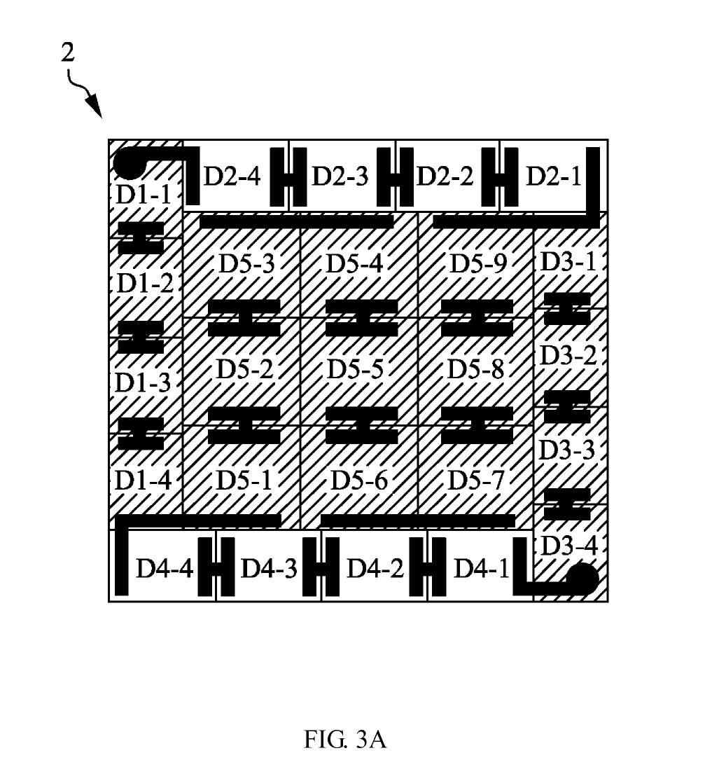

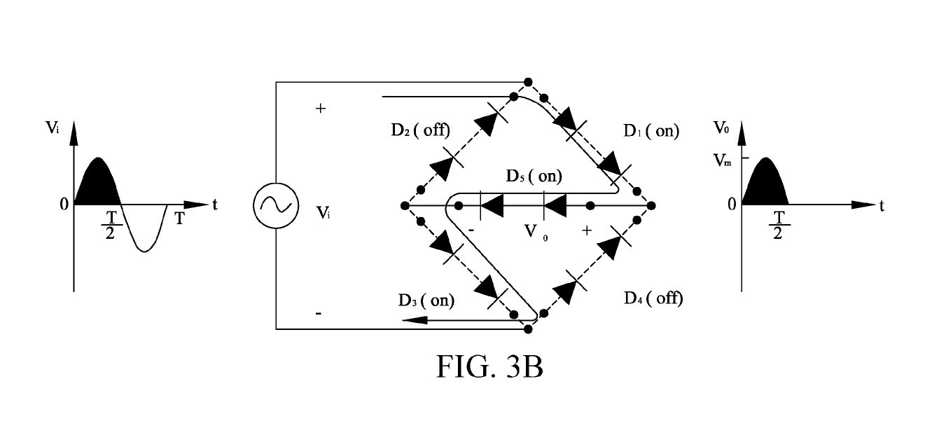

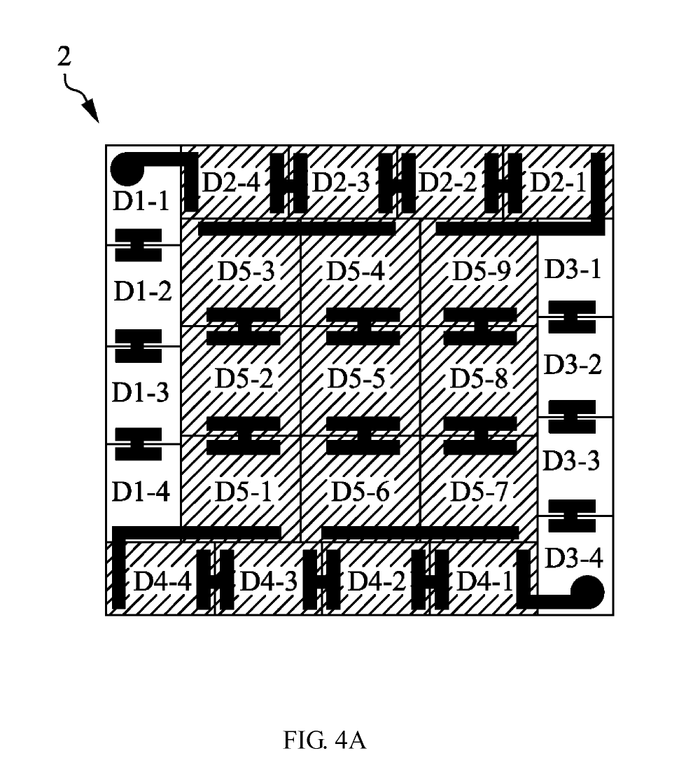

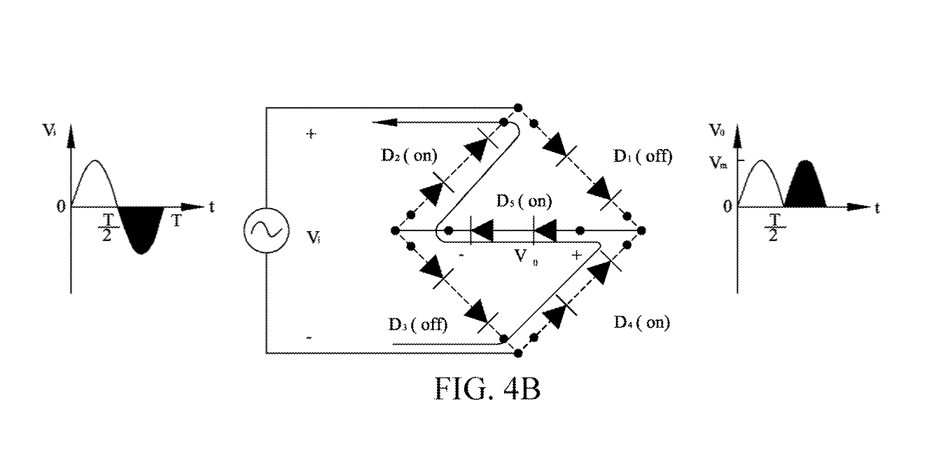

FIG. 2 shows an AC light-emitting device 2 according to an embodiment of the present invention. The AC light-emitting device 2 includes a primary light-emitting module 21 and a secondary light-emitting module 22. Each of the primary light-emitting module 21 and the secondary light-emitting module 22 comprises a plurality of LEDs. The secondary light-emitting module 22 is disposed adjacent to the primary light-emitting module. In this embodiment, the secondary light-emitting module 22 surrounds the primary light-emitting module 21. However, the secondary light-emitting module 22 is not necessarily disposed at a periphery of the primary light-emitting module 21. In another embodiment, the secondary light-emitting module 22 may also be disposed at one side of the primary light-emitting module 21. Alternatively, the secondary light-emitting module 22 may also be disposed at a central portion, and the primary light-emitting module 21 is disposed around the secondary light-emitting module 22 or surrounds the secondary light-emitting module 22. The primary light-emitting module 21 has a plurality of LEDs D5-1 to D5-9 arranged in a matrix. A light-emitting area of each LED in the primary light-emitting module 21 is the same, and at least two LEDs in the plurality of LEDs in the primary light-emitting module 21 are connected in series. The secondary light-emitting module 22 has a plurality of LEDs arranged in a closed manner. A light-emitting area of each LED in the secondary light-emitting module 22 is the same, and a light-emitting area of a single LED in the secondary light-emitting module 22 is smaller than a light-emitting area of a single LED in the primary light-emitting module 21. The plurality of LEDs of the secondary light-emitting module is divided into at least four sub-modules. Each sub-module at least includes four LEDs (for example, D1-1 to D1-4, D2-1 to D2-4, D3-1 to D3-4, and D4-1 to D4-4). At least two sub-modules in the four sub-modules are connected in parallel (for example, the sub-module including the LEDs D1-1 to D1-4 and the sub-module including the LEDs D4-1 to D4-4 are connected in parallel, or the sub-module including the LEDs D2-1 to D2-4 and the sub-module including the LEDs D3-1 to D3-4 are connected in parallel). The plurality of LEDs in each sub-module is connected in series (for example, the equivalent circuit diagram in FIG. 3B or FIG. 4B). When the AC light-emitting device 2 receives an AC power supply, the at least four sub-modules in the secondary light-emitting module 22 is used to rectify the AC input power supply Vi into a DC output voltage V0 for the primary light-emitting module 21. For example, when the AC power supply is in a positive period, in the secondary light-emitting module 22, the sub-module including the LEDs D1-1 to D1-4 and the sub-module including the LEDs D3-1 to D3-4 are used to rectify the power supply, and LEDs in at least two sub-modules in the secondary light-emitting module are turned on and generate brightness (for example, the sub-module including the LEDs D1-1 to D1-4 and the sub-module including the LEDs D3-1 to D3-4). Alternatively, when the AC power supply is in a negative period, in the secondary light-emitting module 22, the sub-module including the LEDs D2-1 to D2-4 and the sub-module including the LEDs D4-1 to D4-4 are used to rectify the power supply, and LEDs in at least two sub-modules in the secondary light-emitting module are turned on and generate brightness (for example, the sub-module including the LEDs D2-1 to D2-4 and the sub-module including the LEDs D4-1 to D4-4). Furthermore, no matter whether the AC power supply is in the positive period or the negative period, since the secondary light-emitting module 22 rectifies the AC power supply into the DC and outputs the DC to the primary light-emitting module 21, each LED (for example, D5-1 to D5-9) in the primary light-emitting module 21 is turned on and generates brightness. Moreover, a total area of the AC light-emitting device 2 is a constant value and is not 0. The total area is a sum of an area of the primary light-emitting module 21 and an area of the secondary light-emitting module 22. Furthermore, an effective light-emitting area of the secondary light-emitting module 22 is obtained by a product of an area of an single LED of the secondary light-emitting module 22 multiplied by the number of the plurality of LEDs of the secondary light-emitting module 22, and multiplied by the duty-on time of the LED of the secondary light-emitting module 22. An effective light-emitting area of the primary light-emitting module 21 is obtained by a product of an area of an single LED of the primary light-emitting module 21 multiplied by the number of the plurality of LEDs of the primary light-emitting module 21, and multiplied by the duty-on time of the LED of the primary light-emitting module 21. In this embodiment, it is assumed that the duty-on time of an LED of the primary light-emitting module 21 is 1, and then the duty-on time of an LED of the secondary light-emitting module 22 is 0.5. A sum of the effective light-emitting area of the primary light-emitting module 21 and the effective light-emitting area of the secondary light-emitting module 22 is an effective light-emitting area of the AC light-emitting device, and the effective light-emitting area is not 0.

For example, in this embodiment, under the premise of not changing the total light-emitting area of the AC light-emitting device 2, the present invention reduces the area of the plurality of LEDs in the secondary light-emitting module 22 and meanwhile increases the area of the plurality of LEDs in the primary light-emitting module 21. It is assumed that the area of each of the LEDs D1-1 to D1-4, D2-1 to D2-4, D3-1 to D3-4, and D4-1 to D4-4 is reduced from 1 to 0.8, and the area of each of the plurality of LEDs D5-1 to D5-9 in the primary light-emitting module 21 may be increased to 1.36, so the total area of the AC light-emitting device 2 is maintained to be 25 (0.8*16+1.36*9=25). Therefore, the effective area of the AC light-emitting device 2 is 16*0.8*0.5+9*1.36*1=18.6 (the duty-on time of the primary light-emitting module is 100%, and the duty-on time of the secondary light-emitting module is 50%). It can be known from the foregoing content that, when the area of each LED in the secondary light-emitting module 22 is reduced to 0.8, the effective light-emitting area can be increased by 9.4%, thereby improving the light-emitting efficiency of the element. In this embodiment, a ratio of a light-emitting area of a single LED in the primary light-emitting module 21 to a light-emitting area of a single LED in the secondary light-emitting module 22 is about 1.7:1.

FIGS. 3A and 3B are schematic circuit operation diagrams of the AC light-emitting device 2 in the case that a time interval is 0 to T/2 and the AC input power supply Vi is a positive signal. It can be known from FIG. 3A that, when the AC input power supply Vi is a positive signal, the LEDs D1-1 to D1-4, and D3-1 to D3-4 in the secondary light-emitting module 22 of the AC light-emitting device 2 are biased to be turned on and emit light, the LEDs D5-1 to D5-9 in the primary light-emitting module 21 are also biased to emit light. FIG. 3B is a schematic equivalent circuit operation diagram of FIG. 3A. When the AC power supply is in a positive period, the light-emitting elements D1, D3, and D5 in the AC light-emitting device 2 are biased to emit light, and Vm represents a maximum voltage peak after rectification.

FIGS. 4A and 4B are schematic circuit operation diagrams of the AC light-emitting device 2 in the case that a time interval is T/2 to T and the AC input power supply Vi is a negative signal. It can be known from FIG. 4A that, the LEDs D2-1 to D2-4, and D4-1 to D4-4 in the secondary light-emitting module 22 of the AC light-emitting device 2 are biased to be turned on and emit light, and the LEDs D5-1 to D5-9 in the primary light-emitting module 21 are also biased to emit light. FIG. 4B is a schematic equivalent circuit operation diagram of FIG. 4A. When the AC power supply is in a negative period, the light-emitting elements D2, D4, and D5 in the AC light-emitting device 2 are biased to emit light, and Vm represents a maximum voltage peak after rectification.

In another embodiment, the present invention can further reduce the area of the plurality of LEDs in the secondary light-emitting module 22 and meanwhile increase the area of the plurality of LEDs in the primary light-emitting module 21. It is assumed that the area of each of the LEDs D1-1 to D1-4, D2-1 to D2-4, D3-1 to D3-4, and D4-1 to D4-4 can be reduced to 0.735, and the area of each of the plurality of LEDs D5-1 to D5-9 in the primary light-emitting module 11 can be increased to 1.47, and the total area of the AC light-emitting device 2 is maintained to be 25 (0.735*16+1.47*9=25). Therefore, the effective area of the AC light-emitting device 2 is 16*0.735*0.5+9*1.47*1=19.11 (the duty-on time of the primary light-emitting module is 100%, and the duty-on time of the secondary light-emitting module is 50%). It can be known from the foregoing content that, when the area of each LED in the secondary light-emitting module 22 is reduced to 0.735, the effective light-emitting area can be increased by 12.4%, thereby improving the light-emitting efficiency of the element. In this embodiment, a ratio of a light-emitting area of a single LED in the primary light-emitting module 21 to a light-emitting area of a single LED in the secondary light-emitting module 22 is 2:1. Since the light-emitting area of a single LED in the primary light-emitting module 21 is increased to twice the light-emitting area of a single LED in the secondary light-emitting module 22, a current density of each LED in the primary light-emitting module 21 is ½ of a current density of each LED in the secondary light-emitting module, thereby balancing the influence caused by the fact that the light-emitting time of the LEDs of the primary light-emitting module is twice the light-emitting time of the LEDs of the secondary light-emitting module, greatly improving the reliability of the each LED in the primary light-emitting module 21, and prolonging the service lift of the whole LEDs.

In yet another embodiment, the present invention can further reduce the area of the plurality of LEDs in the secondary light-emitting module 22 and meanwhile increases the area of the plurality of LEDs in the primary light-emitting module 21. It is assumed that the area of each of the LEDs D1-1 to D1-4, D2-1 to D2-4, D3-1 to D3-4, and D4-1 to D4-4 is reduced to 0.58, and the area of each of the plurality of LEDs D5-1 to D5-9 in the primary light-emitting module 21 may be increased to 1.74, so the total area of the AC light-emitting device 2 is maintained to be 25 (0.58*16+1.74*9=25). Therefore, the effective area of the AC light-emitting device 2 is 16*0.58*0.5+9*1.74*1=19.7 (the duty-on time of the primary light-emitting module is 100%, and the duty-on time of the secondary light-emitting module is 50%). It can be known from the foregoing content that, when the area of each LED in the secondary light-emitting module 22 is reduced to 0.58, the effective light-emitting area can be increased by 19.7%, thereby improving the light-emitting efficiency of the element. In this embodiment, a ratio of a light-emitting area of a single LED in the primary light-emitting module 21 to a light-emitting area of a single LED in the secondary light-emitting module 22 is 3:1.

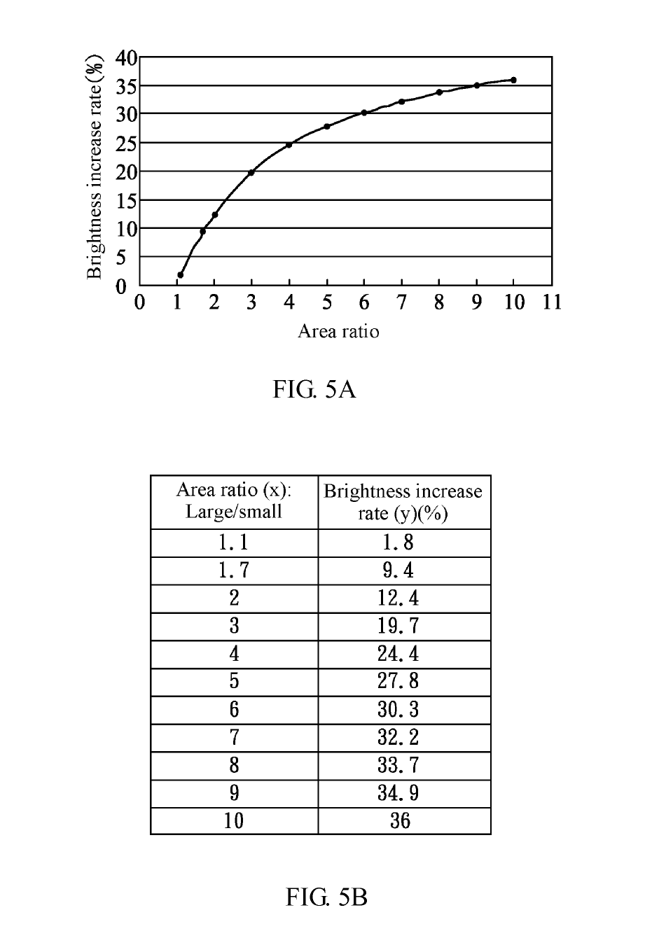

FIGS. 5A and 5B are graphs of a relationship between an area ratio of a single LED in the primary light-emitting module 21 of the AC light-emitting device 2 to a single LED in the secondary light-emitting module 22 and a brightness increase rate of the AC light-emitting device. It can be known from FIGS. 5A and 5B that, when the area ratio is from 1 to 3, the brightness increase rate of the AC light-emitting device is the highest, and as the area ratio increases, the light-emitting brightness is still increased, but the brightness increase rate (the slope) is decreased. The relationship between the area ratio and the brightness increase rate substantially meets the following mathematical relationship:

y=−0.0115x⁴+0.0334x³−3.724x²+20.595x−16.58

where y represents a brightness increase rate of the AC light-emitting device, and x represents an area ratio of a light-emitting area of a single LED in the primary light-emitting module to a light-emitting area of a single LED in the secondary light-emitting module. Preferably, the primary light-emitting module includes nine LEDs, the secondary light-emitting module is includes four sub-modules, and each of the sub-modules has four LEDs. Moreover, when the area ratio is relatively large, the current density of the LEDs of the secondary light-emitting module 22 is further increased, and a higher requirement may be put on the quality of the LED due to the too high current density, so as to prevent the reliability of the whole AC light-emitting device from being reduced. Therefore, preferably, when the area ratio is from 1 to 3, the brightness can be effectively increased, and the reliability of the whole AC light-emitting device can be considered at the same time.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments are chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. An alternating current (AC) light-emitting device, comprising:
a primary light-emitting module, including a plurality of light-emitting diodes (LEDs); and
a secondary light-emitting module, including a plurality of LEDs, wherein the secondary light-emitting module is disposed adjacent to the primary light-emitting module, and a light-emitting area of each LED in the secondary light-emitting module is smaller than a light-emitting area of each LED in the primary light-emitting module.

2. The AC light-emitting device according to claim 1, wherein the primary light-emitting module has the plurality of LEDs spatially arranged in a matrix, and the light-emitting area of each LED in the primary light-emitting module is the same.

3. The AC light-emitting device according to claim 2, wherein at least two LEDs of the plurality of LEDs of the primary module are connected in series.

4. The AC light-emitting device according to claim 1, wherein the secondary light-emitting module has the plurality of LEDs arranged in a closed manner, and the light-emitting area of each LED in the secondary light-emitting module is the same.

5. The AC light-emitting device according to claim 4, wherein the plurality of LEDs of the secondary light-emitting module is divided into at least four sub-modules, and at least two sub-modules in the four sub-modules are connected in parallel.

6. The AC light-emitting device according to claim 5, wherein the plurality of LEDs in each sub-module is connected in series.

7. The AC light-emitting device according to claim 5, wherein when the AC light-emitting device receives an AC power supply, the at least four sub-modules in the secondary light-emitting module are used to rectify the AC power supply into a direct current (DC).

8. The AC light-emitting device according to claim 7, wherein when the AC power supply is in a positive period, the secondary light-emitting module is used to rectify the power supply, and the LEDs in at least two sub-modules in the secondary light-emitting module generate brightness.

9. The AC light-emitting device according to claim 7, wherein when the AC power supply is in a negative period, the secondary light-emitting module is used to rectify the power supply, and the LEDs in at least two sub-modules in the secondary light-emitting module generate brightness.

10. The AC light-emitting device according to claim 7, wherein when the AC power supply is in a positive or negative period, the primary light-emitting module generates brightness.

11. The AC light-emitting device according to claim 1, wherein increasing a light-emitting area of the primary light-emitting module and relatively reducing a light-emitting area of the secondary light-emitting module further improve the light-emitting efficiency of the AC light-emitting device.

12. The AC light-emitting device according to claim 11, wherein the light-emitting area of each LED in the primary light-emitting module is increased, so as to increase the light-emitting area of the primary light-emitting module.

13. The AC light-emitting device according to claim 11, wherein the light-emitting area of each LED in the secondary light-emitting module is reduced, so as to increase the light-emitting area of the primary light-emitting module.

14. The AC light-emitting device according to claim 1, wherein an area ratio of a light-emitting area of a single LED in the primary light-emitting module to a light-emitting area of a single LED in the secondary light-emitting module is from about 1 to 3.

15. The AC light-emitting device according to claim 1, wherein a total area of the AC light-emitting device is a constant value, and the total area is a sum of an area of the primary light-emitting module and an area of the secondary light-emitting module.

16. The AC light-emitting device according to claim 1, wherein an effective light-emitting area of the secondary light-emitting module is obtained by a product of an area of an single LED of the secondary light-emitting module multiplied by the number of the plurality of LEDs of the secondary light-emitting module, and multiplied by the duty-on time of the LED of the secondary light-emitting module.

17. The AC light-emitting device according to claim 16, wherein an effective light-emitting area of the primary light-emitting module is obtained by a product of an area of an single LED of the primary light-emitting module multiplied by the number of the plurality of LEDs of the primary light-emitting module, and multiplied by the duty-on time of the LED of the primary light-emitting module.

18. The AC light-emitting device according to claim 17, wherein a sum of the effective light-emitting area of the primary light-emitting module and the effective light-emitting area of the secondary light-emitting module is an effective light-emitting area of the AC light-emitting device.

19. The AC light-emitting device according to claim 1, wherein a relationship between an area ratio of the primary light-emitting module to the secondary light-emitting module and a brightness increase rate of the AC light-emitting device satisfies with the following relationship:
y=−0.0115x⁴+0.0334x³−3.724x²+20.595x−16.58
wherein y represents a brightness increase rate of the AC light-emitting device, and x represents an area ratio of a light-emitting area of a single LED in the primary light-emitting module to a light-emitting area of a single LED in the secondary light-emitting module.

20. The AC light-emitting device according to claim 19, wherein the primary light-emitting module includes nine LEDs, and the secondary light-emitting module includes four sub-modules, and each of the sub-modules has four LEDs.
